(19) United States
(12) Patent Application Publication
(10) Pub. No.: US 2015/0086854 A1
(43) Pub. Date: Mar. 26, 2015

(54) NONAQUEOUS ELECTROLYTE SECONDARY BATTERY AND BATTERY PACK

(71) Applicant: KABUSHIKI KAISHA TOSHIBA, Tokyo (JP)

(72) Inventors: Shinsuke MATSUNO, Tokyo (JP); Takashi KUBOKI, Tokyo (JP); Keiko OKAMOTO, Kawasaki (JP); Norikazu OSADA, Tokyo (JP); Sara YOSHIO, Yokohama (JP)

(21) Appl. No.: 14/482,175

(22) Filed: Sep. 10, 2014

(30) Foreign Application Priority Data
Sep. 25, 2013 (JP) 2013-197761

(51) Int. Cl. H01M 4/66; H01M 4/134; H01M 4/131; H01M 4/485; H01M 4/38

(52) U.S. Cl. CPC H01M 4/661; H01M 4/485; H01M 4/386; H01M 4/387; H01M 4/131; H01M 4/134; H01M 2004/027
USPC 429/163

(57) ABSTRACT

A nonaqueous electrolyte secondary battery of an embodiment includes an electrode group including a cathode collector, a cathode having a cathode active material layer formed on the cathode collector, an anode collector, an anode having an anode active material layer formed on the anode collector, and a separator placed between the cathode and the anode, an exterior member housing the electrode group, and a nonaqueous electrolyte filled in the exterior member. In the nonaqueous electrolyte secondary battery, the anode collector is at least one metal selected from among Fe, Ti, Ni, Cr, and Al, or an alloy containing at least one metal selected from among Fe, Ti, Ni, Cr, and Al. In the nonaqueous electrolyte secondary battery, a coating containing at least one metal selected from Au and Cu is formed on at least one of the surfaces of the anode collector excluding the anode active material layer.

### CROSS-REFERENCE TO RELATED APPLICATION

This application is based upon and claims the benefit of priority from Japanese Patent Application No. 2013-197761, filed on Sep. 25, 2013; the entire contents of which are incorporated herein by reference.

### FIELD

Embodiments described herein relate to nonaqueous electrolyte secondary batteries and battery packs.

### BACKGROUND

Nonaqueous electrolyte batteries (mostly lithium-ion secondary batteries) have already been put into practical use as the power supplies for a wide variety of fields ranging from small-sized electronic devices to large-sized electric vehicles and the like. The user demands for even smaller size, lighter weight, and longer operating time and life are strong, and there is an increasing demand for higher battery densities and capacities and higher repetitive performance. In a nonaqueous electrolyte battery, a carbon material is normally used as the anode active material, and a layered oxide containing nickel, cobalt, manganese, or the like is used as the cathode active material. However, a conventional carbon material has a limit in increasing its charge/discharge capacity. Also, low-temperature baked carbon that is considered to have a high capacity is low in material density, and therefore, it is difficult to increase the charge/discharge capacity per unit volume. Therefore, to realize high-capacity batteries, development of a new anode material is necessary.

The use of a single metal such as aluminum (Al), silicon (Si), germanium (Ge), tin (Sn), or antimony (Sb) as the anode material for achieving a higher capacity than a carbonaceous material has been suggested. Particularly, where Si is used as the anode material, a high capacity of 4200 mAh per unit weight (1 g) is obtained. However, an anode made of such a single metal repeatedly stores and releases Li. Therefore, microscopic pulverization of elements occurs, and excellent charge-discharge cycling characteristics cannot be achieved.

So as to solve those problems, the use of tin oxide or silicon oxide in an amorphous state is being considered, because tin oxide and silicon oxide in an amorphous state can achieve high capacities and excellent cycling characteristics at the same time. In combination with a carbonaceous material, those oxides can achieve further improvement. However, even if an improved, high-capacity tin oxide or silicon oxide is used, the load on the battery due to volume expansion at a time of charge and contraction at a time of discharge is still very large. Specifically, the copper foil used as collectors is greatly deformed, and internal short-circuiting is likely to occur at the time of the initial charge. Also, holes might be formed in the foil due to repetitive use, and seriously lower the level of security. If a collector that has high tensile strength and is not easily deformed but has low conductivity is used, conduction loss and heat generation become problems.

### BRIEF DESCRIPTION OF THE DRAWINGS

FIG. 1 is a conceptual diagram of a nonaqueous electrolyte secondary battery of an embodiment;

FIG. 2 is an enlarged conceptual diagram of the portion A shown in FIG. 1;

FIG. 3 is an enlarged conceptual diagram of the portion B shown in FIG. 1;

FIG. 4 is a conceptual diagram of a battery pack of an embodiment; and

FIG. 5 is a block diagram showing the electric circuit of the battery pack of the embodiment.

### DETAILED DESCRIPTION

A nonaqueous electrolyte secondary battery of an embodiment includes an electrode group including a cathode collector, a cathode having a cathode active material layer formed on the cathode collector, an anode collector, an anode having an anode active material layer formed on the anode collector, and a separator placed between the cathode and the anode, an exterior member housing the electrode group, and a nonaqueous electrolyte filled in the exterior member. In the nonaqueous electrolyte secondary battery, the anode collector is at least one metal selected from among Fe, Ti, Ni, Cr, and Al, or an alloy containing at least one metal selected from among Fe, Ti, Ni, Cr, and Al. In the nonaqueous electrolyte secondary battery, a coating containing at least one metal selected from Au and Cu is formed on at least one of the surfaces of the anode collector excluding the anode active material layer.

A battery pack of an embodiment includes a nonaqueous electrolyte secondary battery that includes an electrode group including a cathode collector, a cathode having a cathode active material layer formed on the cathode collector, an anode collector, an anode having an anode active material layer formed on the anode collector, and a separator placed between the cathode and the anode, an exterior member housing the electrode group, and a nonaqueous electrolyte filled in the exterior member. In the nonaqueous electrolyte secondary battery, the anode collector is at least one metal selected from among Fe, Ti, Ni, Cr, and Al, or an alloy containing at least one metal selected from among Fe, Ti, Ni, Cr, and Al. In the nonaqueous electrolyte secondary battery, a coating containing at least one metal selected from Au and Cu is formed on at least one of the surfaces of the anode collector excluding the anode active material layer.

### First Embodiment

### First Embodiment

A nonaqueous electrolyte secondary battery according to a first embodiment is now described.

The nonaqueous electrolyte secondary battery according to the first embodiment includes: an electrode group that includes a cathode collector, a cathode having a cathode active material layer formed on the cathode collector, an anode collector, an anode having an anode active material layer formed on the anode collector, and a separator placed between the cathode and the anode; an exterior member that houses the electrode group; and a nonaqueous electrolyte that is filled in the exterior member.

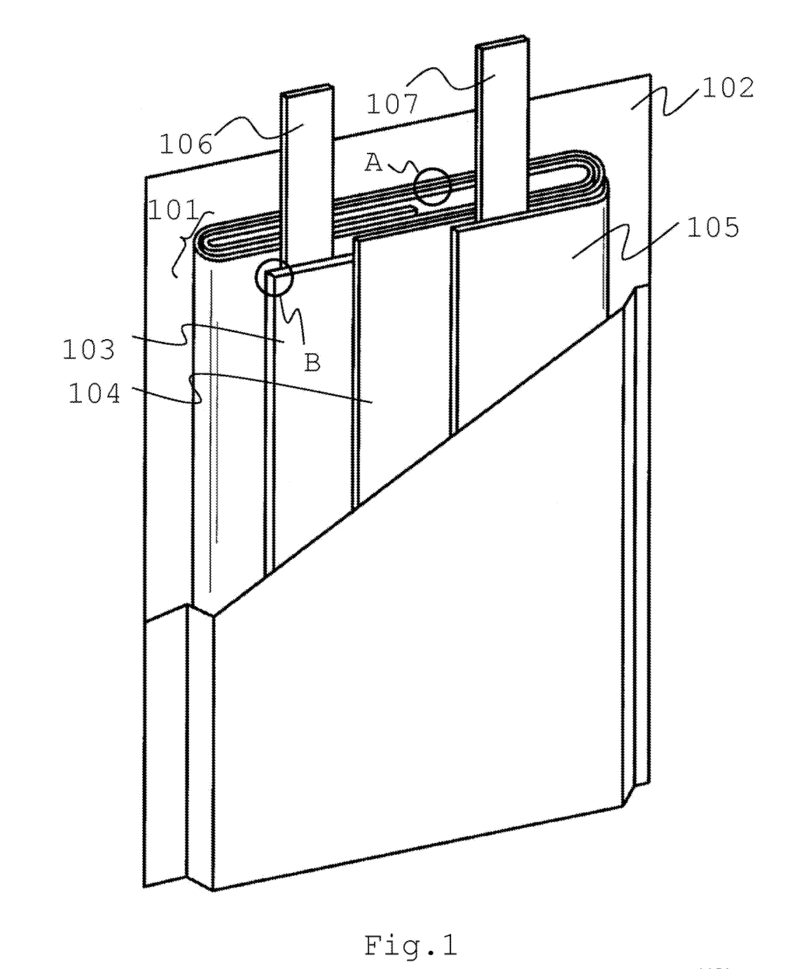

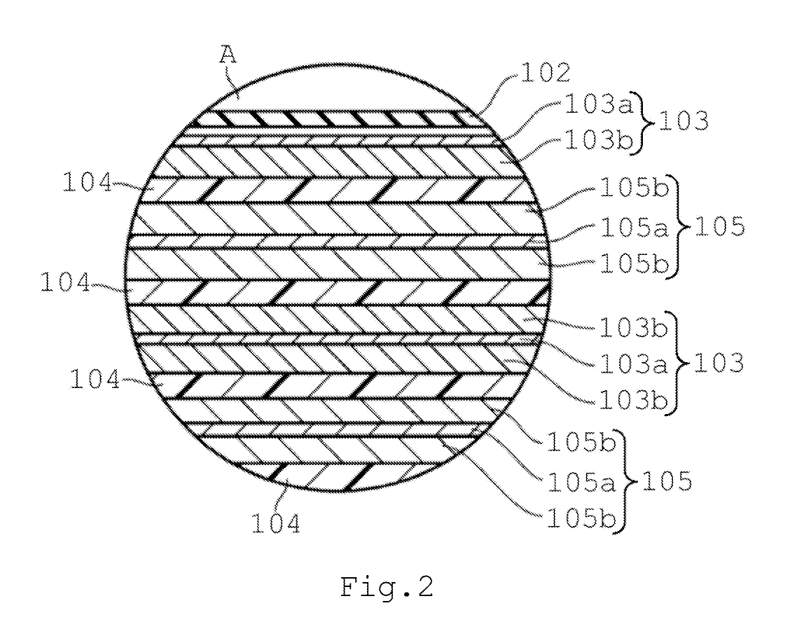

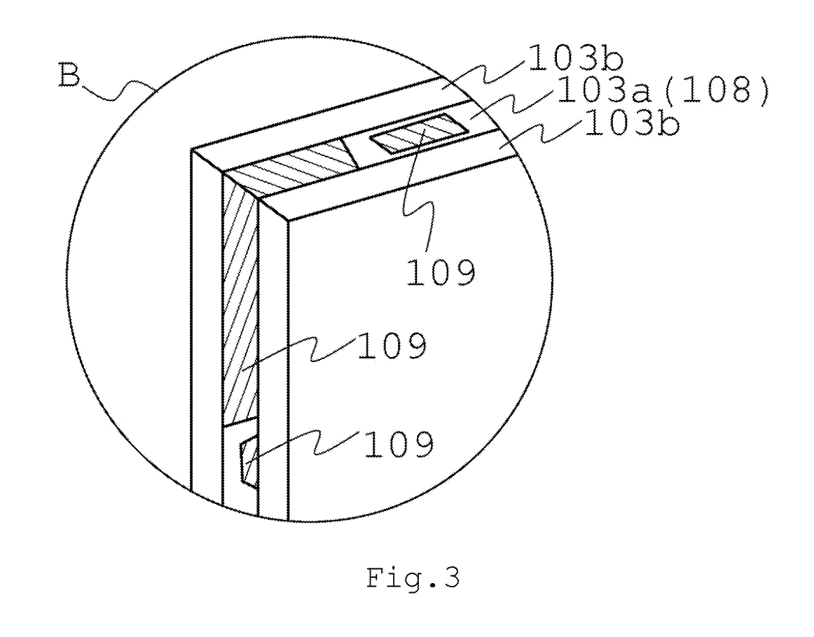

Referring now to FIGS. 1, 2, and 3, an example of the nonaqueous electrolyte secondary battery 100 according to this embodiment is described in greater detail. FIG. 1 is a conceptual diagram of the flat nonaqueous electrolyte secondary battery 100 that has an exterior member 102 formed with a laminated film. FIG. 2 is an enlarged cross-sectional view of the portion A shown in FIG. 1. FIG. 3 is an enlarged cross-sectional view of the portion B shown in FIG. 1. The respective drawings are conceptual diagrams designed for explanation, and the shapes, sizes, and ratios shown in the drawings might differ from those of actual devices, but can be arbitrarily changed by taking into account the following description and known arts.

An electrode group 101 is housed in the bag-like exterior member 102 formed from a laminated film having aluminum foil interposed between two resin layers. The electrode group 101 is formed by spirally winding a stack structure formed by stacking an anode 103, a separator 104, a cathode 105, and a separator 104 in this order from the outer side, and is then press-molded. The outermost portion of the anode 103 has a structure in which an anode active material layer 103b is formed on the inside surface of an anode collector 103a as shown in FIG. 2. Each of the other portions of the anode 103 has an anode active material layer 103b formed on either surface of the anode collector 103a. The active material in the anode active material layer 103b contains a battery active material according to the first embodiment. The cathode 105 has cathode active material layers 105b formed on both surfaces of a cathode collector 105a. A coating 109 is formed on at least one of surfaces of the anode collector excluding the anode active material layer. As shown in FIG. 3, the coating 109 is provided on side surfaces 108 that exclude the principal surfaces (a first principal surface and a second principal surface) in which the anode active material of the anode collector 103a exists.

Although a flat wound structure in the drawings, the electrode group 101 may have a cylindrical wound structure. Further, the electrode group 101 may have a stack structure in which an anode, a separator, and a cathode are stacked, instead of a wound structure.

In the vicinity of the edge of the outer circumference of the electrode group 101, an anode terminal 106 is electrically connected to the anode collector 103a of the outermost portion of the anode 103, and a cathode terminal 107 is electrically connected to the cathode collector 105a of the cathode 105 on one surface of the inner side of the outermost portion of the anode 103. The anode terminal 106 and the cathode terminal 107 extend to the outside through an opening of the bag-like exterior member 102. A liquid nonaqueous electrolyte is introduced through the opening of the bag-like exterior member 102. The opening of the bag-like exterior member 102 is heat-sealed, with the anode terminal 106 and the cathode terminal 107 being interposed therein. In this manner, the electrode group 101 and the liquid nonaqueous electrolyte are completely enclosed.

The anode terminal 106 may be aluminum or an aluminum alloy containing an element such as Mg, Ti, Zn, Mn, Fe, Cu, or Si, for example. So as to lower contact resistance to the anode collector 103a, the anode terminal 106 is preferably the same material as the anode collector 103a.

The cathode terminal 107 may be made of a material that has electrical stability and conductivity at potential of 3 to 4.25 V with respect to lithium ion metal. Specifically, aluminum or an aluminum alloy containing an element such as Mg, Ti, Zn, Mn, Fe, Cu, or Si can be used. So as to lower contact resistance to the cathode collector 105a, the cathode terminal 107 is preferably the same material as the cathode collector 105a.

The exterior member 102, the cathode 105, the anode 103, the electrolyte, and the separator 104, which are components of the nonaqueous electrolyte secondary battery 100, will be described below in detail.

### 1) Exterior Member

The exterior member 102 is formed from a laminated film having a thickness of 0.5 mm or smaller. Alternatively, a metal container having a thickness of 1.0 mm or smaller is used as the exterior member 102. More preferably, the metal container has a thickness of 0.5 mm or smaller.

The exterior member 102 may be flattened (thinned) in shape, or may have a rectangular shape, a cylindrical shape, a coin-like shape, or a button-like shape. Examples of the exterior member 102 include a small-battery exterior member mounted on a portable electronic device or the like, and a large-battery exterior member mounted on two- or four-wheeled vehicle or the like, depending on battery size.

The laminated film is a multilayer film having a metal layer interposed between resin layers. So as to reduce weight, the metal layer is preferably aluminum foil or aluminum alloy foil. The resin layers may be made of a polymeric material such as polypropylene (PP), polyethylene (PE), nylon, or polyethylene terephthalate (PET). The laminated film can be formed into the shape of an exterior member by thermal adhesion sealing.

The metal container is made of aluminum, an aluminum alloy, or the like. The aluminum alloy is preferably an alloy containing an element such as magnesium, zinc, or silicon. If the alloy contains a transition metal such as iron, copper, nickel, or chromium, the amount thereof is preferably 100 mass ppm or smaller.

### 2) Cathode 105

The cathode 105 has a structure in which the cathode active material layer (s) 105b containing an active material is (are) supported by one or both surfaces of the cathode collector 105a.

The thickness of each of the above described cathode active material layers 105b is preferably not smaller than 1.0 μm and not greater than 150 μm, so as to maintain large-current discharge characteristics and the cycle life of the battery. Therefore, in a case where there are cathode active material layers 105b supported by both surfaces of the cathode collector 105a, the total thickness of the cathode active material layers 105b is preferably not smaller than 20 μm and not greater than 300 μm. More preferably, the thickness of one cathode active material layer 105b is not smaller than 30 μm and not greater than 120 μm. With the thickness falling within this range, the large-current discharge characteristics and the cycle life improve.

The cathode active material layers 105b may contain a conducting agent other than a cathode active material.

The cathode active material layers 105b may also contain a binding agent that binds cathode materials.

As the cathode active material, various kinds of oxides, such as manganese dioxide, a lithium-containing cobalt oxide (LiCoO₂, for example), a lithium-containing nickel cobalt oxide (LiNi_{0.8}CO_{0.2}O₂, for example), and a lithium-manganese composite oxide (LiMn₂O₄ or LiMnO₂, for example), are preferable, because a high voltage can be obtained with any of those oxides.

Examples of conducting agents include acetylene black, carbon black, and graphite.

Specific examples of binding agents include polytetrafluoroethylene (PTFE), polyvinylidene fluoride (PVdF), ethylene-propylene-diene copolymer (EPDM), and styrene-butadiene rubber (SBR).

As for the proportions of the cathode active material, the conducting agent, and the binding agent, the cathode active material is preferably in the range of 80 mass % to 95 mass the conducting agent is preferably in the range of 3 mass % to 18 mass %, and the binding agent is preferably in the range of 2 mass to 7 mass %, so as to achieve excellent large-current discharge characteristics and an excellent cycle life.

A porous conductive substrate or a non-porous conductive substrate can be used as the cathode collector 105a. The thickness of the cathode collector 105a is preferably not smaller than 5 μm and not greater than 20 μm. Within this range, high electrode strength and an electrode weight reduction can be realized at the same time.

The cathode 105 is formed by suspending the active material, the conducting agent, and the binding agent in a widely-used solvent to prepare a slurry, applying the slurry to the cathode collector 105a, drying the slurry, and performing pressing, for example. Alternatively, the cathode 105 may be formed by preparing the active material, the conducting agent, and the binding agent in pellets to form the cathode active material layers 105b on the cathode collector 105a.

### 3) Anode 103

The anode 103 has a structure in which the anode active material layer(s) 103b containing an anode material is (are) supported by one surface or both surfaces of the anode collector 103a. In a case where an anode active material layer 103b exists only on one surface of the anode collector 103a, the one surface is a first principal surface, and the surface that is on the opposite side from the first principal surface and does not have an anode active material layer 103b thereon is a second principal surface. In a case where an anode active material layers 103b exist on either surface of the anode collector 103a, the one of the surfaces is the first principal surface, and the surface that is on the opposite side from the first principal surface is the second principal surface. Of the surfaces of the anode collector 103a, the surfaces excluding the first principal surface and the second principal surface are the side surfaces 108 of the anode collector 103a.

A porous conductive substrate or a non-porous conductive substrate can be used as the anode collector 103a. The thickness of the anode collector 103a is preferably not smaller than 5 μm and not greater than 20 μm. Within this range, high electrode strength and an electrode weight reduction can be realized at the same time.

The anode collector 103a is a sheet-like metal film, and has the surfaces with larger areas as the principal surfaces. There are two surfaces with the larger areas, and these are the first principal surface and the second principal surface. The side surfaces extending in the thickness direction of the principal surfaces are surfaces having smaller areas than the principal surfaces. The side surfaces extending in the thickness direction of the principal surfaces are the side surfaces 108 that exclude the first principal surface and the second principal surface. If the anode collector 103a has a cylindrical shape, for example, there is only one side surface 108. There should be one or more side surfaces 108. On part of at least one of the side surfaces 108, the coating 109 that contains a different metal from the metal contained in the anode collector 103a is provided.

The principal surface(s) on which the anode active material layer 103b exists is (are) the portions to which the anode active material layer 103b is applied on both or one of the surfaces of the anode collector 103a. For example, so as to extract current, a lead portion that is integrally formed with the anode collector 103a and does not have the anode active material layer 103b applied to the two surfaces thereof may extend from the principal surface on which the anode active material layer 103b exist. However, this portion is not regarded as part of the principal surface on which the anode active material layer 103b exists.

So as to lower the internal resistance of the anode 103, the electrical resistivity of the metal contained in the coating 109 is preferably lower than the electrical resistivity of the anode collector 103a. Also, so as to lower the internal resistance of the anode 103, the coating 109 is preferably formed so that at least one of the anode active material layer 103b on the first principal surface and the anode active material layer 103b on the second principal surface is short-circuited to the anode collector 103a.

With this short-circuited structure, electrical contact can be increased.

The component material of the anode collector 103a is preferably a metal or an alloy containing at least one of Fe, Ti, Ni, Cr, and Al. If the anode collector 103a contains at least one of Fe, Ti, Ni, Cr, and Al, the mechanical strength such as the tensile strength of the anode collector 103a tends to increase, and the anode collector 103a is not easily deformed. Preferably, 80 atomic % or more of Fe is contained.

The electrical resistivities of Au and Cu, which can be used in the coating 109, are 2.21×10⁻⁸ mΩ (Au) and 1.68×mΩ (Cu), respectively. The electrical resistivities of Fe, Ti, Ni, Cr, and Al, which can be used in the anode collector 103a, are 1.00×10⁻⁷ mΩ (Fe), 4.27×10⁻⁷ mΩ (Ti), 6.99×mΩ (Ni), 1.29×10⁻⁷ mΩ (Cr), and 2.65×10⁻⁸ mΩ (Al), respectively. In this manner, the electrical resistivity of the metal contained in the coating 109 is lower than the electrical resistivity of the anode collector 103a.

The metal contained in the coating 109 preferably contains at least one of Au and Cu. So as to lower the internal resistance of the anode 103 and improve large-current discharge characteristics, Au and Cu are preferable, having low electrical resistivities. The metal contained in the coating 109 may contain Ni, Cr, or the like, other than Au and Cu. So as to lower the internal resistance of the anode 103, the metal contained in the coating 109 preferably accounts for 80 atomic % or more in the coating 109.

Other than the metal, the coating 109 may contain a metal compound containing the metal. The metal compound may include a metal oxide or a metal organic material. Particularly, an organic compound containing a metal and a metal oxide have the effect to prevent elution of the metal from the coating 109. The amount of the metal compound preferably accounts for 20 atomic % or less in the coating 109. If the metal compound amount exceeds 20 atomic % in the coating 109, the original effect to lower resistance becomes smaller. The qualitation and quantification of the metal or the metal compound in the coating 109 can be measured by scraping the subject material off the side surfaces 108 of the anode 103 and using inductively coupled plasma mass spectroscopy (ICP-MS) or the like.

The thickness of the thickest portion of the coating 109 is preferably 1 μm or smaller. The coating thickness of the coating 109 is uniform or not uniform. If the thickest portion of the coating 109 is thicker than 1 μm, film detachment easily occurs when the battery is manufactured. Moreover, the advantageous effects become smaller, and the detached metal or metal compound as an impurity enters the battery, resulting in internal short-circuiting or the like.

The coating 109 may not cover all the side surfaces 108. Specifically, the coating 109 has a meshed pattern or an irregular pattern. The coverage of the coating 109 on the side surfaces 108 is preferably 50% or higher. When the coverage of the coating 109 is equal to or higher than a certain value, the resistance lowering effect can be achieved. If the coverage of the coating 109 is lower than 100%, the period of time required for the coating process can be shortened. If the coverage is lower than 50%, the resistance lowering effect becomes smaller. The coverage is preferably 75% or higher. The coverage and the coating thickness of the coating 109 on the side surfaces 108 can be determined by observing all the surfaces of the anode 103 with an electron microscope. The coverage of the coating 109 on the side surfaces 108 can be measured with a scanning electron microscope-energy dispersive X-ray microanalyzer (SEM-EDX) or the like.

The coverage of the portion of the coating 109 existing on the surface having the largest area among the side surfaces 108 is preferably higher than the coverage of the portion of the coating 109 existing on the surface having the smallest area among the side surfaces 108. As the coverage on a side surface having a large area is higher, electrical resistance can be more efficiently reduced. In a case where the battery has the electrode group shown in FIG. 1, the surface having the largest area among the side surfaces 108 is each side surface extending in the length direction of the anode collector 103a. Also, in the case where the battery has the electrode group shown in FIG. 1, the surface having the smallest area among the side surfaces 108 is each side surface extending in the width direction of the anode collector 103a.

The product (the abundance) of the coverage of the portion of the coating 109 existing on the surface having the largest area among the side surfaces 108 and the largest thickness of the coating 109 is preferably larger than the product (the abundance) of the coverage of the portion of the coating 109 existing on the surface having the smallest area among the side surfaces 108 and the largest thickness of the coating 109. Since the abundance of the coating 109 on the side surfaces having the larger areas more effectively contributes to a decrease in resistance, the above mentioned relationship is preferably satisfied.

As a specific example, a case where the side surfaces of a collector made of a stainless steel material containing iron as a principal component are coated with copper is now described. The electrical resistivity of the stainless steel material containing iron as a principal component is 10⁻⁷ Ωm, and the electrical resistivity of copper is 10 Ωm (at 20° C.) The inventors manufactured batteries having the same structures, except for the anode collectors 103a. Stainless steel foil and copper foil of 12 μm were used as the anode collectors 103a. As a result, it became apparent that the AC resistance of the anode 103 including the stainless steel foil as the anode collector 103a was approximately three times higher than the AC resistance of the anode 103 including the copper foil as the anode collector 103a. The AC resistances were measured at 1 kHz and at 25° C., in the presence of 50% of SOC.

So as to lower the resistance of the stainless steel foil, the inventors manufactured anode active material layers 103b, and conducted vapor deposition of copper of approximately 0.05 μm having a low electrical resistivity on all the surfaces of the stainless steel foil on which the anode active material layers 103b were not formed. In this manner, a battery was manufactured. The 1-kHz AC resistance was also measured at 25° C. in the presence of 50% of SOC, to find almost no improvement compared with the AC resistance in the case where vapor deposition was not conducted. As a result of intensive studies, the inventors are of the opinion, though not certain, that vapor deposition on all the surfaces caused insufficient contact among the collector foil, the vapor-deposited layer, and the active material layers, and rather increased the contact resistance, failing to lower the resistance at the time of battery manufacturing. With this in mind, another battery was manufactured by conducting vapor deposition of copper only on the side surfaces to which any active material was not applied. In the battery, the resistance was almost 30% lowered, compared with the resistance observed in the case where vapor deposition was not conducted. By coating the side surfaces with a different metal (not necessarily copper) having a low electrical resistivity, the resistance can be effectively lowered, without an increase in the contact resistance to the active material layers.

The anode active material in the anode active material layers 103b preferably contains at least one active material selected from among silicon, a silicon-containing oxide, tin, and a tin-containing oxide. Other than the anode active material, the anode active material layers 103b contains a binding agent, and may further contain a conducting aid.

The anode active material in the anode active material layers 103b is preferably at least one of silicon, a silicon-containing oxide, tin, and a tin-containing oxide. The silicon-containing oxide is SiOₓ (1<x≦2), and may have Si deposited on the surface of SiOₓ. The tin-containing oxide is SnOₓ (1<x≦2), and may have Sn deposited on the surface. So as to improve the cycle performance of the active material, substitution may be performed with a very small amount of another element. Furthermore, the silicon-containing oxide and the tin-containing oxide may be coated with carbon.

A carbon material is normally used as the anode conducting agent. The carbon material preferably exhibits excellent storage properties and high conductivity with respect to alkali metals. Examples of carbon materials include acetylene black, carbon black, and graphite having high crystallinity.

Examples of binding agents include polytetrafluoroethylene (PTFE), polyvinylidene fluoride (PVdF), fluororubber, ethylene-butadiene rubber (SBR), polypropylene (PP), polyethylene (PE), carboxymethyl cellulose (CMC), polyimide (PI), and polyacrylimide (PAI).

As for the proportions of the anode active material, the conducting agent, and the binding agent in the anode active material layers 103b, the anode active material is preferably in the range of 70 mass % to 95 mass %, the conducting agent is preferably in the range of 0 mass % to 25 mass %, and the binding agent is preferably in the range of 2 mass % to 10 mass %. Lastly, the silicon element and the tin element in the anode active material layers 103b each preferably have an atom rate of 5% to 80% relative to the carbon element.

### 4) Electrolyte

As for the electrolyte, a nonaqueous electrolytic solution, an electrolyte-impregnated polymer electrolyte, a polymer electrolyte, or an inorganic solid electrolyte can be used.

A nonaqueous electrolytic solution is a liquid electrolytic solution prepared by dissolving an electrolyte in a nonaqueous solvent, and is held in the voids in the electrode group.

The nonaqueous solvent is preferably a nonaqueous solvent containing, as a main component, a mixed solvent of propylene carbonate (PC) or ethylene carbonate (EC) and a nonaqueous solvent (hereinafter referred to as the second solvent) having lower viscosity than PC and EC.

The second solvent is preferably a chain carbon, and examples of such chain carbons include dimethyl carbonate (DMC), methylethyl carbonate (MEC), diethyl carbonate (DEC), ethyl propionate, methyl propionate, γ-butyrolactone (EL), acetonitrile (AN), ethyl acetate (EA), toluene, xylene, and methyl acetate (MA). One of those second solvents or a mixture of two or more of those second solvents can be used. The number of donors in the second solvent is preferably 16.5 or smaller.

The viscosity of the second solvent is preferably 2.8 cmp or lower at 25° C. The proportion of the ethylene carbonate or the propylene carbonate in the mixed solvent is preferably not lower than 1.0% and not higher than 80% in volume ratio. More preferably, the proportion of the ethylene carbonate or the propylene carbonate is not lower than 20% and not higher than 75% in volume ratio.

Examples of electrolytes that can be contained in the nonaqueous electrolytic solution include lithium salts (electrolytes) such as lithium perchlorate (LiClO₄), lithium hexafluorophosphate (LiPF₆), lithium tetrafluoroborate (LiBF₄), lithium arsenic hexafluoride (LiAsF₃), lithium trifluoromethasulfonate (LiCF₃SO₃), and bistrifluoromethyl sulfonyl imide lithium [LiN(CF₃SO₂)₂]. Particularly, it is preferable to use LiPF₆ or LiBF₄.

The amount of the electrolyte dissolved in the nonaqueous solvent is preferably not smaller than 0.5 mol/L and not larger than 2.0 mol/L.

### 5) Separator 104

In a case where a nonaqueous electrolyte or an electrolyte-impregnated polymer electrolyte is used, the separator 104 can be used. The separator 104 is a porous separator. The material of the separator 104 may be a porous film containing polyethylene, polypropylene, or polyvinylidene fluoride (PVdF), or a nonwoven cloth made of synthetic resin, for example. Particularly, so as to increase safety of the secondary battery, a porous film made of polyethylene and/or polypropylene is preferable.

The thickness of the separator 104 is preferably 30 μm or smaller. If the thickness is greater than 30 μm, the distance between the cathode and the anode becomes longer, and internal resistance might become higher. The lower limit value of the thickness is preferably 5 μm. If the thickness is smaller than 5 μm, the strength of the separator 104 becomes much lower, and internal short-circuiting might easily occur. More preferably, the upper limit value of the thickness is 25 μm, and the lower limit value is 1.0 μm.

The separator 104 preferably has a thermal shrinkage of 20% or lower when left at 120° C. for one hour. If the thermal shrinkage exceeds 20%, the possibility of short-circuiting due to heating becomes higher. The thermal shrinkage is preferably 15% or lower.

The porosity of the separator 104 is preferably in the range of 30% to 70%. The reason for that is as follows. If the porosity is lower than 30%, it might be difficult for the separator 104 to achieve excellent electrolyte holding properties. If the porosity exceeds 70%, on the other hand, the separator 104 might not have sufficient strength. A more preferable range of the porosity is from 35% to 70%.

The air transmission rate of the separator 104 is preferably 500 seconds/100 cm³ or lower. If the air transmission rate exceeds 500 seconds/100 cm³, it might be difficult to achieve high lithium ion mobility in the separator 104. The lower limit value of the air transmission rate is 30 seconds/100 cm³. If the air transmission rate is lower than 30 seconds/100 cm³, the separator 104 might not have sufficient strength.

More preferably, the upper limit value of the air transmission rate is 300 seconds/100 cm³, and the lower limit value is 50 seconds/100 cm³.

### Second Embodiment

Next, a battery pack using the above described nonaqueous electrolyte secondary battery is described.

The battery pack according to a second embodiment contains one or more nonaqueous electrolyte secondary batteries (or electric batteries) according to the above described embodiment. The single batteries are used as cells of the battery pack. In a case where the battery pack contains electric batteries, the respective electric batteries are electrically connected in series, in parallel, or in both series and parallel.

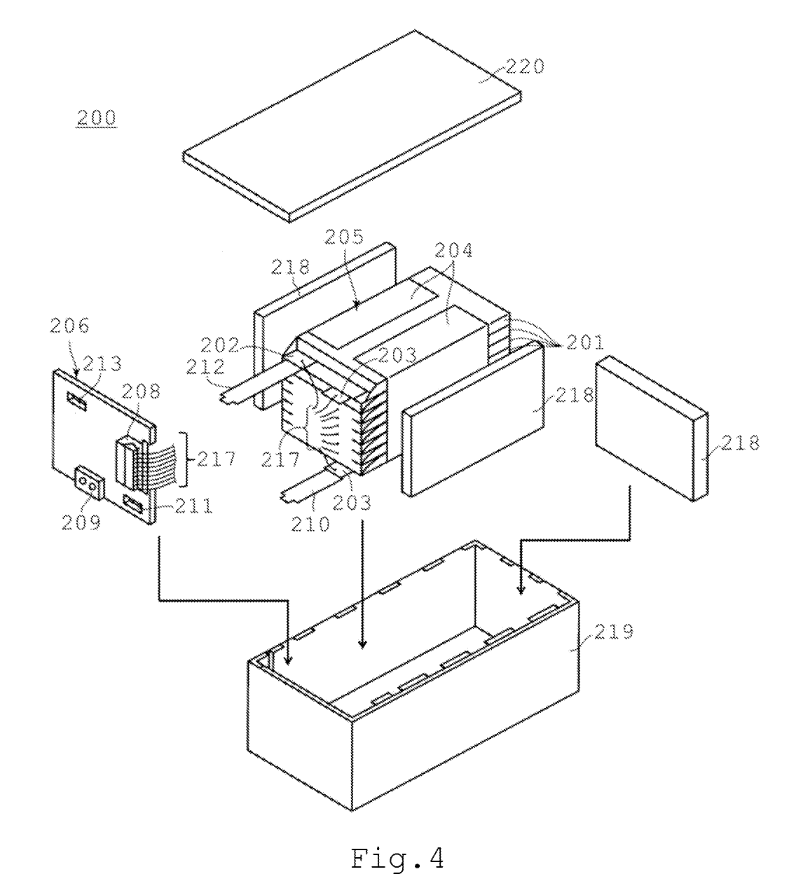

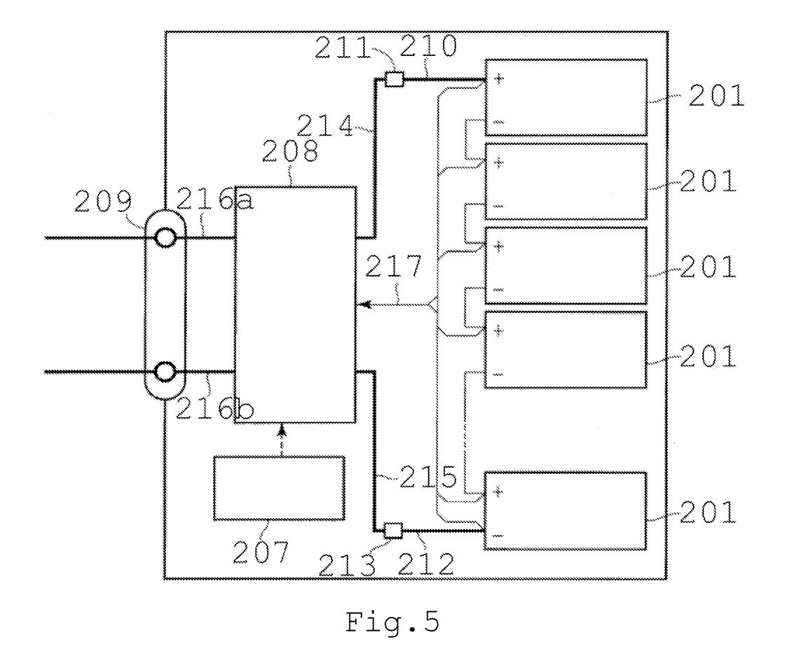

Referring now to the conceptual diagram shown in FIG. 4 and the block diagram shown in FIG. 5, the battery pack 200 is described in detail. The battery pack 200 shown in FIG. 5 uses the flat nonaqueous electrolyte secondary battery 100 shown in FIG. 1 as a single battery 201.

The single batteries 201 are stacked so that anode terminals 202 and cathode terminals 203 extending to the outside are oriented in the same direction, and are bound with an adhesive tape 204 to form an assembled battery 205. These single batteries 201 are electrically connected in series to one another as shown in FIG. 5.

A printed circuit board 206 is placed to face the side surfaces of the single batteries 201 from which the anode terminals 202 and the cathode terminals 203 extend. As shown in FIG. 5, a thermistor 207, a protection circuit 208, and an energizing terminal 209 for an external device are mounted on the printed circuit board 206. An insulating panel (not shown) is attached to the surface of the printed circuit board 206 facing the assembled battery 205, so as to avoid unnecessary connections with the wirings of the assembled battery 205.

A cathode-side lead 210 is connected to the cathode terminal 203 located in the lowermost layer of the assembled battery 205, and the end thereof is inserted into and electrically connected to a cathode-side connector 211 of the printed circuit board 206. An anode-side lead 212 is connected to the anode terminal 202 located in the uppermost layer of the assembled battery 205, and the end thereof is inserted into and electrically connected to an anode-side connector 213 of the printed circuit board 206. These connectors 211 and 213 are connected to the protection circuit 208 through wirings 214 and 215 formed on the printed circuit board 206.

The thermistor 207 is used to detect temperature of the single batteries 201, and detected signals are transmitted to the protection circuit 208. Under predetermined conditions, the protection circuit 208 can cut off a positive-side wiring 216a and a negative-side wiring 216b provided between the protection circuit 208 and the energizing terminal 209 for an external device. One of the predetermined conditions is that a detected temperature of the thermistor 207 is equal to or higher than a predetermined temperature, for example. Another one of the predetermined conditions is that overcharge, overdischarge, overcurrent, or the like of the single batteries 201 is detected. Overcharge or the like is detected from each individual single battery 201 or all the single batteries 201. When each individual single battery 201 is examined, a battery voltage may be detected, or a cathode or anode potential may be detected. In the latter case, a lithium electrode to be used as a reference electrode is inserted into each individual electric battery 201. In the example case illustrated in FIGS. 4 and 5, wirings 217 for voltage detection are connected to the respective single batteries 201, and detected signals are transmitted to the protection circuit 208 through these wirings 217.

A protective sheet 218 made of rubber or resin is attached to each of the three side surfaces of the assembled battery 205, except for the side surface from which the cathode terminals 203 and the anode terminals 202 protrude.

The assembled battery 205 as well as the respective protective sheets 218 and the printed circuit board 206 are housed in a housing container 219. That is, the protective sheets 218 are provided on both inner side surfaces extending in the length direction of the housing container 219 and one inner side surface extending in the width direction, and the printed circuit board 206 is provided on the other inner side surface extending in the width direction. The assembled battery 205 is located in the space surrounded by the protective sheets 218 and the printed circuit board 206. A lid 320 is attached to the upper surface of the housing container 219.

To secure the assembled battery 205, a heat-shrinkable tape may be used, instead of the adhesive tape 204. In that case, protective sheets are attached to both side surfaces of the assembled battery, and the heat-shrinkable tape is wound around the assembled battery. The heat-shrinkable tape is made to shrink with heat and bind the assembled battery.

Although the single batteries 201 are connected in series in FIGS. 4 and 5, the single batteries 201 may be connected in parallel or in both series and parallel, so as to increase the battery capacity. Assembled battery packs may be further connected in series or parallel.

According to the above described embodiment, a battery pack that achieves excellent charge-discharge cycle performance by including nonaqueous electrolyte secondary batteries of the foregoing embodiment having excellent charge-discharge cycle performance can be provided.

The form of the battery pack may be appropriately modified in accordance with the purpose of use. The battery pack is preferably used in an environment where a small-sized, large-capacity battery pack is required. Specifically, the battery pack may be used in a smartphone or a digital camera, or may be mounted on a two- to four-wheeled hybrid electric vehicle, a two- to four-wheeled electric vehicle, or a power-assisted bicycle, for example.

Specific examples (specific examples of batteries of FIG. 1 manufactured under respective conditions described in the respective Examples) will be described below, and the effects thereof will be explained. However, embodiments are not limited to these examples.

### Example 1

[Manufacturing of a Cathode]

First, a slurry was prepared by adding 90 mass % of lithium-nickel-manganese-cobalt composite oxide (LiNi_{1/3}Mn_{1/3}Co_{1/3}O₂) particles as an active material, 5 mass % of acetylene black, and 5 mass I of polyvinylidene fluoride (PVdF) to N-methylpyrrolidone, followed by mixing. This slurry was applied to aluminum foil (a collector) of 15 μm in thickness. After dried, the aluminum foil was pressed to form a cathode having cathode active material layers of 3.2 g/cm³ in density.

[Manufacturing of an Anode]

First, a slurry was prepared by adding 80 mass of silicon oxide particles (SiO), 10 mass of hard carbon particles, and 10 mass % of polyimide (PI) to NMP, followed by mixing. This slurry was applied to stainless steel foil of 10 μm in thickness, and the stainless steel foil was dried and pressed, to form an electrode having a coated portion of 55 mm in the vertical direction and 850 mm in the transverse direction. Here, the direction of the short side is defined as the vertical direction, and the direction of the long side is defined as the transverse direction. After vapor deposition of copper was conducted in the vertical direction in a vacuum atmosphere, the electrode was loosely wound in the transverse direction, and vapor deposition of copper was also conducted in the transverse direction. The vapor deposition of copper was conducted on both the short and long side surfaces. The copper was then heated in an argon gas at 500° C. for eight hours, to form an anode having anode active material layers of 1.6 g/cm³ in density.

The coating on the side surfaces extending in the length direction of the collector of an electrode manufactured under the same conditions as above was examined by XPS. As a result, Cu metal signals were observed, and small peaks of Cu²⁺ derived from an oxide or a metal compound were also observed. The abundance of the Cu metal in the coating calculated from the peak ratio was 98%. The measurement was continued while edging was being performed. As a result, the largest height was 0.05 μm. Also, SEM-EDX measurement was conducted, to observe the coated states of the side surfaces. The coverage of the coating was 87%.

The SEM-EDX measurement was conducted on unspecified portions extending from the spot located at 22.75 mm±5 mm in the vertical direction and 425 mm±5 mm in the transverse direction, which is almost the center point in the electrode of 55 mm in the vertical direction and 850 mm in the transverse direction.

Likewise, XPS measurement was conducted at almost the center positions on the side surfaces extending in the width direction of the collector, to find Cu metal and Cu²⁺ derived from a copper oxide or a copper metal compound in the coating, as in the case of the measurement in the length direction. The largest height of the coating was 0.01 μm. The coated portion was also measured by SEM-EDX. After images were observed at 3000-fold magnification, the element ratio was measured by EDX. The proportions of Fe and Cu, which were the largest components of the collector, were calculated. The proportion of Cu to the total proportion of Fe and Cu was regarded as the proportion of the coated portion. As a result, the portion coated with the coating on the side surfaces accounted for 67%. The abundance of the coating in the vertical direction and the abundance of the coating in the transverse direction were simply calculated by multiplying the largest coating height by the coverage. Accordingly, the abundance in the vertical direction was 0.04 μm×0.67=0.0268, and the abundance in the transverse direction was 0.05 μm×0.87=0.0435. The abundance ratio between the vertical direction and the transverse direction was 0.0268 (vertical)/0.0435 (transverse)=0.616. Since the ratio is less than 1, the abundance of the coating on the side surfaces extending in the transverse direction was determined to be larger than the abundance of the coating on the side surfaces extending in the vertical direction.

[Manufacturing of an Electrode Group]

The cathode, a separator formed with a porous polyethylene film, the anode, and the separator were stacked in this order, and were wound in a spiral form so that the anode is located in the outermost layer. In this manner, the electrode group was manufactured.

[Preparation of a Nonaqueous Electrolyte]

Ethylene carbonate (EC) and methylethyl carbonate (MEC) were mixed at 1:2 in volume ratio, to form a mixed solvent. In this mixed solvent, lithium hexafluorophosphate (LiPF₆) was dissolved at 1.0 mol/L, to prepare a nonaqueous electrolyte.

[Preparation of a Nonaqueous Electrolyte Secondary Battery]

The electrode group and the nonaqueous electrolyte were put into a stainless-steel cylindrical container having a bottom. One end of an anode lead was connected to the anode of the electrode group, and the other end was connected to the cylindrical container that had a bottom and served as an anode terminal.

An insulating sealing plate having a cathode terminal engaged with the center portion thereof was then prepared. One end of a cathode lead was connected to the cathode terminal, and the other end was connected to the cathode of the electrode group. The insulating sealing plate was then caulked to the upper opening of the container, to assemble a cylindrical nonaqueous electrolyte secondary battery that had the above described structure shown in FIG. 1 and had a capacity of 3 Ah.

The obtained secondary battery was charged at 4.3 V at a rate of 0.2 C in a 25° C. environment, and was then discharged at a rate of 0.2 C until it reached 2 V. After that, charge and discharge was repeated once at a rate of 1 C in a 25° C. environment, and the capacity was examined.

### Examples 2 Through 10

Anodes having the respective structures shown in Table 1 were manufactured. Nonaqueous electrolyte secondary batteries were manufactured in the same manner as in Example 1, except for the anodes.

### Comparative Examples 1 and 2

Anodes having the respective structures shown in Table 1 were manufactured. Nonaqueous electrolyte secondary batteries were manufactured in the same manner as in Example 1, except for the anodes.

TABLE 1A

| | Collector | | Proportion | Presence or Absence |
|---|---|---|---|---|
| | (Containing | Coating | of Metal in | of Metal Oxide |
| | Metal) | Metal | Coating | or Metal Compound |
| Example 1 | Fe, Cr | Cu | 98% | Present |
| Example 2 | Fe, Cr | Cu | 80% | Present |
| Example 3 | Fe, Ti, Cr | Au, Cu | 86% | Present |
| Example 4 | Ni, Ti, Al | Au, Cu | 92% | Present |
| Example 5 | Ni, Al, Ti | Au, Cu | 95% | Present |
| Example 6 | Fe, Ni | Au | 82% | Present |
| Example 7 | Fe, Ti | Cu | 95% | Present |
| Example 8 | Fe, Ti, Cr | Cu | 87% | Present |
| Example 9 | Fe, Ti, Cr | Au, Cu | 97% | Present |
| Example 10 | Ni, Ai, Ti | Au, Cu | 82% | Present |
| Comparative | Cu | Not | N/A | Absent |
| Example 1 | | Coated | | |
| Comparative | Fe, Cr | Not | N/A | Absent |
| Example 2 | | Coated | | |

TABLE 1B

| | Largest | | Short Side/ |
|---|---|---|---|
| | Height of | | Long Side |
| | Coating Metal | Coverage | Ratio |
| Example 1 | 0.05 μm | 87% | 0.616 |
| Example 2 | 0.03 μm | 78% | 0.523 |
| Example 3 | 1.00 μm | 96% | 0.743 |
| Example 4 | 0.04 μm | 50% | 0.932 |
| Example 5 | 0.08 μm | 68% | 1.000 |
| Example 6 | 0.95 μm | 76% | 0.247 |
| Example 7 | 0.82 μm | 55% | 0.533 |
| Example 8 | 0.28 μm | 85% | 0.847 |
| Example 9 | 0.13 μm | 98% | 0.359 |
| Example 10 | 0.52 μm | 68% | 0.711 |
| Comparative | N/A | N/A | N/A |
| Example 1 | | | |
| Comparative | N/A | N/A | N/A |
| Example 2 | | | |

After the capacities of the batteries of Examples 1 through 10 and Comparative Examples 1 and 2 were measured, the SOC was adjusted to 50%, and battery voltages and AC resistances at 1 kHz were measured. With the resistance of Comparative Example 1 being 1, comparisons with Examples and the other Comparative Example were conducted. After the batteries were stored in a 0° C. environment for one week, voltage measurement was again conducted in a 25° C. environment. The degrees of short-circuiting were determined from voltage changes before and after the 1-week storage. As the storage test was conducted in a 0° C. environment, internal short-circuiting (semi-short-circuiting) can be distinguished from self-discharge as a chemical reaction. Lastly, the SOC was again adjusted to 50%, and the batteries were broken down into components in an inert atmosphere. Presence or absence of deformation of the anodes (active material layer detachment, wrinkles, or holes) was visually confirmed. The results are shown in Table 2.

TABLE 2

| | 1-kHz AC | | | Anode |
|---|---|---|---|---|
| | Resistance | Voltage Drop | | Deformation |
| Example 1 | 1.6 | 25 | mV | Not Found |
| Example 2 | 1.8 | 16 | mV | Not Found |
| Example 3 | 1.3 | 70 | mV | Not Found |
| Example 4 | 1.2 | 21 | mV | Not Found |
| Example 5 | 1.1 | 28 | mV | Not Found |
| Example 6 | 1.5 | 62 | mV | Not Found |
| Example 7 | 1.4 | 55 | mV | Not Found |
| Example 8 | 1.1 | 32 | mV | Not Found |
| Example 9 | 1.2 | 22 | mV | Not Found |
| Example 10 | 1.3 | 41 | mV | Not Found |
| Comparative | 1.0 | 120 | mV | Found |
| Example 1 | | | | |
| Comparative | 3.2 | 20 | mV | Not Found |
| Example 2 | | | | |

The above results show that, in Comparative Example 1 using Cu as the collector, the resistance was low, but the anode was greatly deformed, and internal short-circuiting occurred. In a case where stainless steel was used as the collector as in Comparative Example 2, deformation of the anode was suppressed, but the resistance was almost three times higher than the resistance in the case where Cu was used as the collector. In Examples 1 through 10, which are embodiments of the disclosed technique, on the other hand, internal short-circuiting was prevented, and resistances were lowered, while deformation of the anodes was suppressed.

The above results show that the nonaqueous electrolyte secondary batteries of Comparative Examples 1 and 2 had lower capacity retention rates and larger amounts of self-discharge than the nonaqueous electrolyte secondary batteries of Examples 1 through 10. Those batteries were broken down into components, and the anodes were observed. Large wrinkles were found in some of the anode active material layers, there was large detachment of active material layers, or some of the collectors have small holes (Table 2).

As described so far, under the conditions of the disclosed technique, deformation of the collectors due to volume expansion can be greatly suppressed while high capacities are retained.

In the specification, some of the elements are represented simply by chemical symbols.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonaqueous electrolyte secondary battery comprising:
an electrode group including: a cathode collector; a cathode having a cathode active material layer formed on the cathode collector; an anode collector; an anode having an anode active material layer formed on the anode collector; and a separator placed between the cathode and the anode;
an exterior member configured to house the electrode group; and
a nonaqueous electrolyte filled in the exterior member,
wherein
the anode collector is at least one metal selected from among Fe, Ti, Ni, Cr, and Al, or an alloy containing at least one metal selected from among Fe, Ti, Ni, Cr, and Al, and
a coating containing at least one metal selected from Au and Cu is formed on at least one of surfaces of the anode collector excluding the anode active material layer.

2. The battery according to claim 1, wherein
the anode active material layer is formed on a first principal surface of the anode collector or on the first principal surface and a second principal surface located on the opposite side from the first principal surface, and
the coating is formed on at least one of side surfaces of the anode collector excluding the first principal surface and the second principal surface.

3. The battery according to claim 1, wherein the coating has a thickness of 1 μm or smaller.

4. The battery according to claim 1, wherein the coating contains a metal compound containing the at least one metal selected from Au and Cu.

5. The battery according to claim 2, wherein the at least one of the side surfaces has a region where the coating exists and a region where the coating does not exist.

6. The battery according to claim 2, wherein coverage of the coating existing on the at least one of the side surfaces is 50% or higher.

7. The battery according to claim 2, wherein a product of coverage of the coating existing on a surface having the largest area among the side surfaces and the largest thickness of the coating is larger than a product of coverage of the coating existing on a surface having the smallest area among the side surfaces and the largest thickness of the coating.

8. The battery according to claim 1, wherein the coating causes the anode collector to be short-circuited to at least one of the anode active material layer on the first principal surface and the anode active material layer on the second principal surface.

9. The battery according to claim 1, wherein the anode active material layer contains at least one of silicon, a silicon-containing oxide, tin, and a tin-containing oxide.

10. A battery pack comprising
a nonaqueous electrolyte secondary battery including:
an electrode group including: a cathode collector; a cathode having a cathode active material layer formed on the cathode collector; an anode collector; an anode having an anode active material layer formed on the anode collector; and a separator placed between the cathode and the anode;
an exterior member configured to house the electrode group; and
a nonaqueous electrolyte filled in the exterior member,
wherein
the anode collector is at least one metal selected from among Fe, Ti, Ni, Cr, and Al, or an alloy containing at least one metal selected from among Fe, Ti, Ni, Cr, and Al, and
a coating containing at least one metal selected from Au and Cu is formed on at least one of surfaces of the anode collector excluding the anode active material layer.

11. The battery pack according to claim 10, wherein
the anode active material layer is formed on a first principal surface of the anode collector or on the first principal surface and a second principal surface located on the opposite side from the first principal surface, and
the coating is formed on at least one of side surfaces of the anode collector excluding the first principal surface and the second principal surface.

12. The battery pack according to claim 10, wherein the coating has a thickness of 1 μm or smaller.

13. The battery pack according to claim 10, wherein the coating contains a metal compound containing the at least one metal selected from Au and Cu.

14. The battery pack according to claim 11, wherein the at least one of the side surfaces has a region where the coating exists and a region where the coating does not exist.

15. The battery pack according to claim 11, wherein coverage of the coating existing on the at least one of the side surfaces is 50% or higher.

16. The battery pack according to claim 11, wherein a product of coverage of the coating existing on a surface having the largest area among the side surfaces and the largest thickness of the coating is larger than a product of coverage of the coating existing on a surface having the smallest area among the side surfaces and the largest thickness of the coating.

17. The battery pack according to claim 10, wherein the coating causes the anode collector to be short-circuited to at least one of the anode active material layer on the first principal surface and the anode active material layer on the second principal surface.

18. The battery pack according to claim 10, wherein the anode active material layer contains at least one of silicon, a silicon-containing oxide, tin, and a tin-containing oxide.
